(19) United States
(12) Patent Application Publication
(10) Pub. No.: US 2011/0025834 A1
(43) Pub. Date: Feb. 3, 2011

(54) Method and apparatus of identifying human body posture

(75) Inventors: Maolin Chen, Beijing city (CN); Rufeng Chu, Beijing city (CN)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/805,457

(22) Filed: Jul. 30, 2010

(30) Foreign Application Priority Data
Jul. 31, 2009 (CN) 200910161452.7
Apr. 20, 2010 (KR) 10-2010-0036589

(51) Int. Cl. H04N 7/18

(52) U.S. Cl. 348/77; 348/E07.091

(57) ABSTRACT

Disclosed is a human body posture identifying method and apparatus. The apparatus may include an input module including a depth camera and a color camera, a preprocessing module to perform a preprocess and to generate a posture sample, a training module to calculate a projective transformation matrix, and to establish a NNC, a feature extracting module to extract a distinguishing posture feature, a template database establishing module to establish a posture template database, a searching module to perform a human body posture matching, and an output module to output a best match posture, and to relocate a location of a virtual human body model.

### CROSS-REFERENCE TO RELATED APPLICATIONS

This application claims the benefit of Korean Patent Application No. 10-2010-0036589, filed on Apr. 20, 2010, in the Korean Intellectual Property Office, and Chinese Patent Application No. 200910161452.7, filed on Jul. 31, 2009 in the State Intellectual Property Office of the Peoples' Republic of China, the disclosures of which are incorporated herein by reference.

### BACKGROUND

1. Field

One or more embodiments relate to a computer vision technology, and more particularly, to a real-time identification of a human body posture and a motion analysis and forecast.

2. Description of the Related Art

A human body motion analysis and a human body posture identification are important technologies, and the technologies may be used for embodying interaction between a human and a machine, a virtual 3D interactive game, a 3D posture identification, and the like, based on meaningful human postures. A study on a human body motion capturing has drawn attention due to academic and commercial value.

Various methods to analyze a human body motion have been provided. Some methods may require attaching a predetermined mark to a target or may require using a predetermined motion capturing equipment, and thus may be inconvenient for a user in a general environment, for example, a home entertainment, a 3D interactive game, and the like, and may limit a use of the methods. The mark used for the human motion analysis has not been significantly studied in actual practice. A conventional method may be roughly classified into two methods, namely, an analysis based on parts of a human body and an analysis based on a sample. A method used by a conventional art may be classified into a method based on a color image and a 3D laser scanning human body model auxiliary method.

The color image may provide 2D information, such as a color, a pattern, a shape, and the like, and thus the 2D information may have a difficulty in determining a posture. For example, when a part of a human body is self-occluded, the human body posture may not be accurately identified based on the color image due to an uncertainty of the human body posture of the color image.

Although an improved posture extracting method is used, color information providing an uncertain posture may cause a low processing speed and inaccurate inference about the posture. In addition, the color information is not reliable or is not robust due to a change in seasons, a change in clothes of a human, and a change in a lighting environment. A human body identification method based on the color information in a complex environment may not accurately identify the human body posture.

Accordingly, many researchers and engineers may prefer to obtain a more accurate result based on a 3D model by scanning with a laser. However, a laser scanner may not be used in a real environment, for example, a home entertainment, a 3D interactive game, and the like, due to a high cost of the capturing equipment and a huge size of the capturing equipment. Thus, there is a desire for a method and apparatus to identify the human body posture in a complex environment in real time.

### SUMMARY

An aspect of embodiments provides a color camera and a time of flight (TOF) depth camera combined to focus on a human body motion analysis or a human body posture identification without writing a mark, the combined TOF depth camera simultaneously providing a depth image and an intensity image.

Another aspect of embodiments provides a human body posture identifying method and apparatus to identify a human body posture in a complex environment, and the method and apparatus effectively identify the human body posture based on depth information and color information.

According to an aspect, there is provided a human body posture identifying apparatus, and the apparatus includes an input module including a depth camera and a color camera to simultaneously capture the human body posture to generate an input image, a preprocessing module to perform a preprocess for converting the input image into an appropriate format, to unify a size of the input image based on a predetermined size, and to generate a posture sample having an independent shape to generate sample data, a training module to calculate a projective transformation matrix from an original image space to a feature space by decreasing a dimension of the sample data based on a statistical learning method during a training operation, and to establish a nearest neighbor classifier (NNC), a feature extracting module to extract a distinguishing posture feature from the sample data based on the projective transformation matrix during each of the training operation and a human body posture identifying operation, a template database establishing module to establish a posture template database based on the distinguishing posture feature extracted by the feature extracting module during the training operation, a searching module to perform a human body posture matching by comparing, through the NNC, the distinguishing posture feature extracted by the feature extracting module during the human body posture identifying operation with a posture template stored in the posture template database, and an output module to output a best match posture, and to relocate a location of a virtual human body model based on the best match posture.

According to another aspect, there is provided a human body posture identifying method, and the method includes simultaneously capturing a human body posture using both a depth camera and a color camera to generate an input image, performing a preprocess to transform the input image into an appropriate format, unifying a size of the input image based on a predetermined size, generating a posture sample having an independent shape to generate sample data, calculating a projective transformation matrix from an original image space to a feature space by decreasing a dimension of the sample data based on a statistical learning method during a training operation, and establishing an NNC, extracting a distinguishing posture feature from the sample data based on the projective transformation matrix during each of the training operation and a human body posture identifying operation, establishing a posture template database based on the distinguishing posture feature extracted during the training operation, performing a human body posture matching by comparing, through the NNC, the distinguishing posture feature extracted during the human body posture identifying operation with a posture template stored in the posture template database, and outputting a best match posture, and to relocate a location of a virtual human body model based on the best match posture.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. These and/or other aspects and advantages will become apparent and more readily appreciated from the following description of the embodiments, taken in conjunction with the accompanying drawings of which:

FIG. 1 is a block diagram illustrating a human body posture identifying apparatus according to an embodiment;

FIG. 2 is a diagram illustrating a sample image that is captured by an input module according to an embodiment;

FIG. 3 is a flowchart illustrating a human body posture identifying method according to an embodiment;

FIG. 4 is a diagram illustrating an image processing procedure of a preprocessing module according to an embodiment;

FIGS. 5A-5D are diagrams illustrating an example of measuring a location of shoulders according to an embodiment;

FIG. 6 is a diagram illustrating a training procedure of a classifier of a training module of FIG. 1;

FIG. 7 is a diagram illustrating a template database establishing procedure of a template database establishing module of FIG. 1;

FIG. 8 is a diagram illustrating a feature extracting procedure of a feature extracting module of FIG. 1;

FIG. 9 is a diagram illustrating a feature matching procedure of a searching module and a human body posture outputting procedure of an outputting module, of FIG. 1; and

FIGS. 10, 11A-11B, 12, 13A-13B are diagrams illustrating experiment 1 and experiment 2 performed according to embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosures by referring to the figures

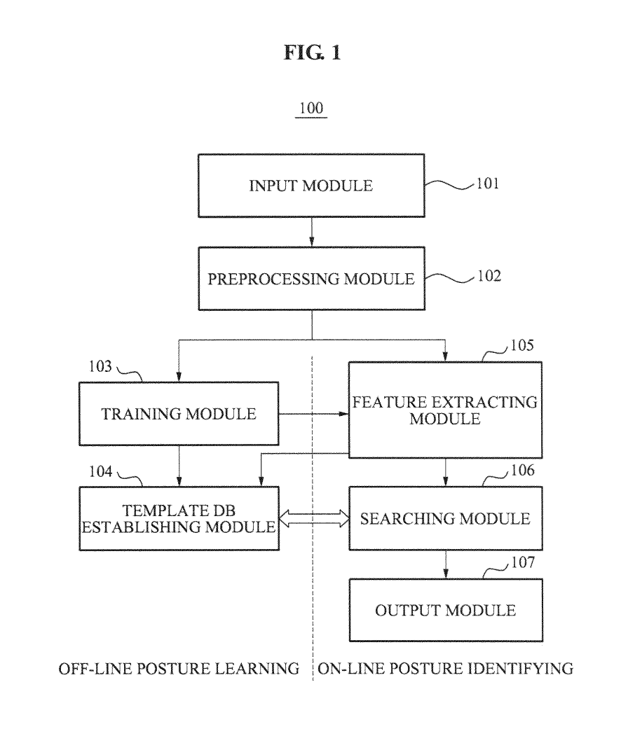

FIG. 1 illustrates a human body posture identifying apparatus according to an embodiment. The human body posture identifying apparatus 100 may include an input module 101, a preprocessing module 102, a training module 103, a template database (DB) establishing module 104, a feature extracting module 105, a searching module 106, and an output module 107.

The input module 101 may include two cameras, namely, a depth camera and a color camera, and the depth camera may be, for example, a time of flight (TOF) depth camera. The TOF depth camera and the color camera may simultaneously capture a human body posture to generate an input image.

The preprocessing module 102 may perform a preprocess to convert the input image into an appropriate format, and may unify the input image based on a predetermined size to generate a posture sample having an independent shape. Initial data of the unified sample may have a high dimension.

After the preprocess is performed, the training module 103 may decrease the dimension of sample data based on a statistical learning method, such as a principle component analysis (PCA) method, a local linear embedding (LLE) method, and the like, during a training operation, namely, during a learning operation, to obtain a projective transformation matrix from an original image space to a feature space, namely, to obtain a feature selecting mechanism to extract a feature, and may establish a nearest neighbor classifier (NNC).

The template DB establishing module 104 may establish an off-line initial posture template DB to identify the human body posture. The template DB establishing module 104 may have a mark manually written for different human body postures.

Subsequently, the feature extracting module 105 may extract a distinguishing posture feature from the sample data based on the projective transformation matrix during the training operation, and the template DB establishing module 104 may establish a relationship between the distinguishing posture feature and a related posture. The feature extracting module 105 may extract only the distinguishing posture feature based on the projective transformation matrix.

The searching module 106 may receive the distinguishing posture feature and may compare, through an NNC, a distinguishing posture feature extracted by the feature extracting module 105 during a human body identifying operation with a posture template stored in the posture template database to perform a human body posture matching. Subsequently, the output module 107 may provide a best match posture and may relocate a location of a virtual human body model. Thereafter, an entire human body identifying procedure is completed.

The same scene is simultaneously captured by two cameras. A camera is the TOF depth camera, and the other camera is the color camera. The color camera may be a conventional charged coupled device/complementary metal oxide semiconductor (CCD/CMOS) camera and may provide a color image. The TOF depth camera may provide a depth image and an intensity image. The depth image may indicate a distance between a target and the TOF depth camera. The intensive image may indicate an intensity energy of light that the TOF depth camera receives.

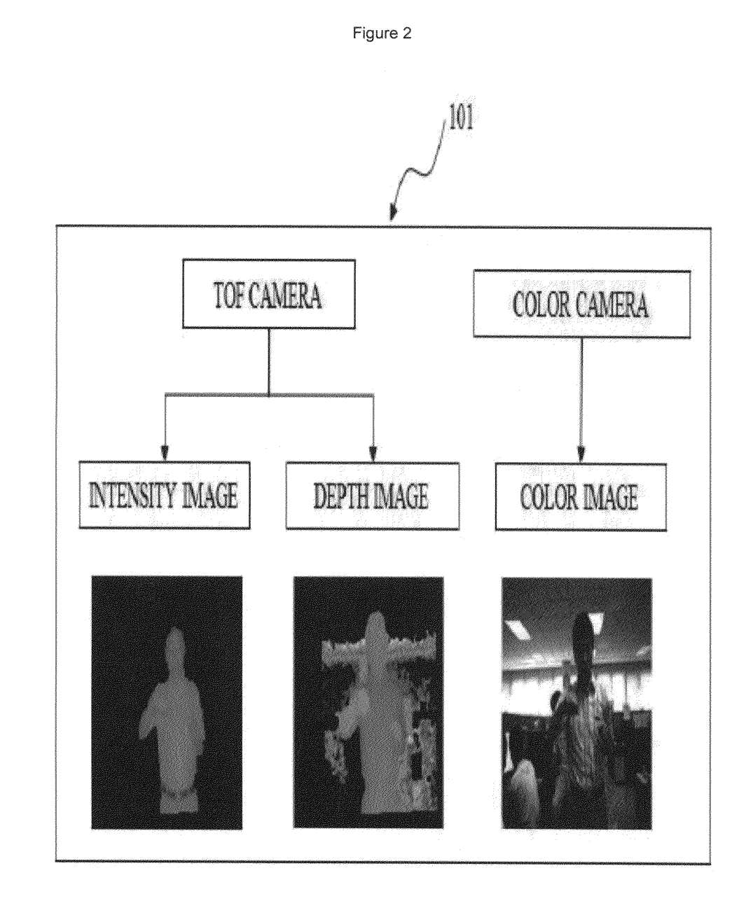

FIG. 2 illustrates a sample image that is captured by the input module 101 according to an embodiment.

Referring to FIG. 2, an intensity image provides a clear background image, and the background image may be appropriate for extracting a foreground image and for extracting an outline. A location of a head and a location of a body may be intuitively and easily detected based on an intensity image having a clear background. When glasses worn by a person is excessively reflecting light, the intensity image may not be best for detecting a location of eyes.

Therefore, the location of the eyes may be measured based on a color image. There are various methods to measure the location of the eyes from the color image. In addition, an analysis on a human body based on the color image and an analysis on the human body based on an outline image may be different. An inaccurate analysis on the human body may be reduced by sufficiently using the depth image.

After three input images, namely, the color image, the depth image, and the intensity image are obtained, a preprocess converting the three images to an appropriate format may be performed. The preprocess may be performed with respect to an image based on the three input images.

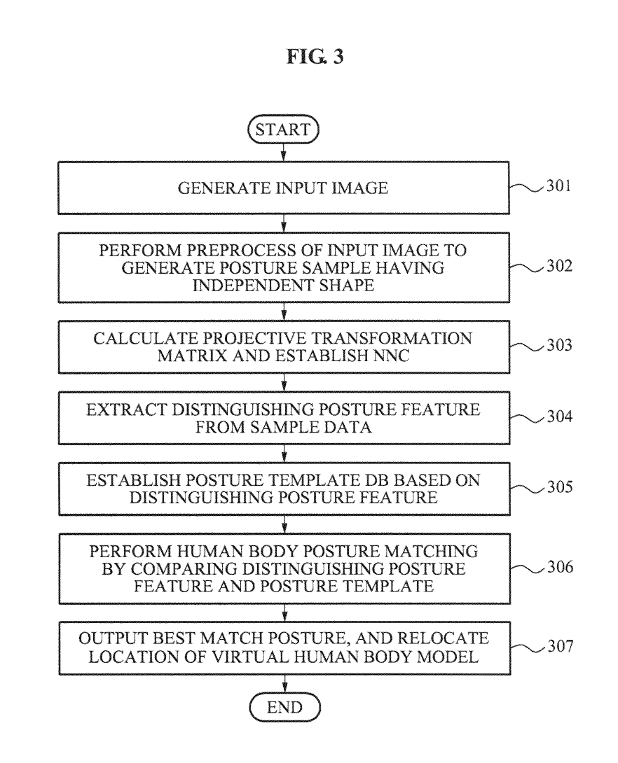

FIG. 3 illustrates a human body posture identifying method according to an embodiment.

Referring to FIG. 3, a depth camera and a color camera in the input module 101 simultaneously capture a human body posture to generate an input image in operation 301.

In operation 302, the preprocessing module 102 performs a preprocess for converting the input image, unifies the input image based on a predetermined size, and generates a posture sample having an independent shape.

In operation 303, the training module 103 decreases a dimension of the sample data based on a statistical learning method during a training operation to calculate a projective transformation matrix from an original image space to a feature space, and establishes an NNC.

In operation 304, the feature extracting module 105 extracts a distinguishing posture feature from the sample data based on the projective transformation matrix during each of the training operation and a human body posture identifying operation.

In operation 305, the template DB establishing module 104 establishes a posture template DB based on the distinguishing posture feature extracted during the training operation.

In operation 306, the searching module 106 compares, through the NNC, the distinguishing posture feature extracted by the feature extracting module 105 during the human body posture identifying operation with a posture template stored in the posture template database, and performs a human body posture matching.

In operation 307, the output module 107 outputs a best match posture, and relocates a location of a virtual human body model based on the best match posture.

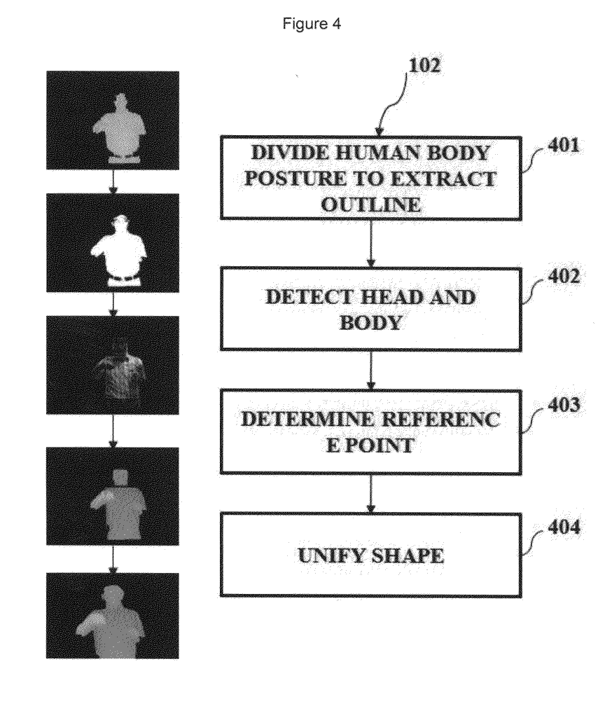

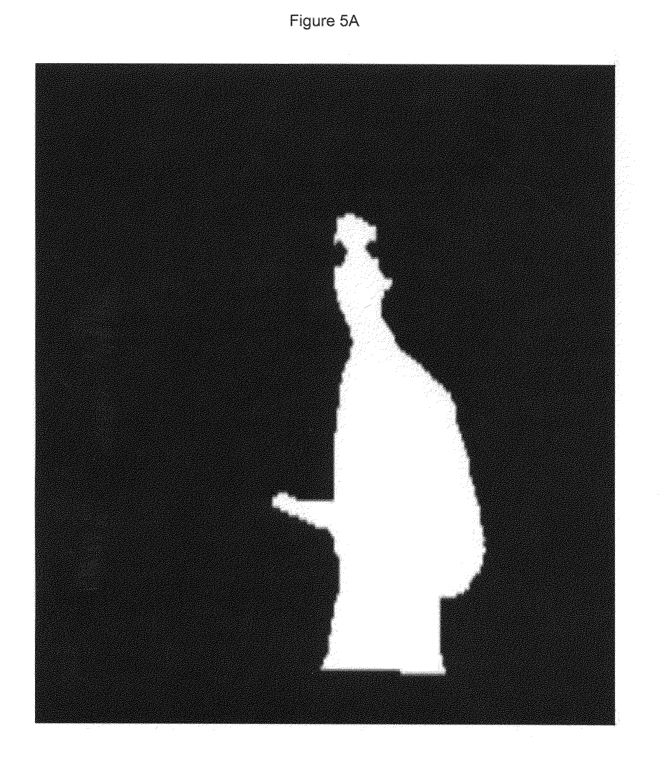

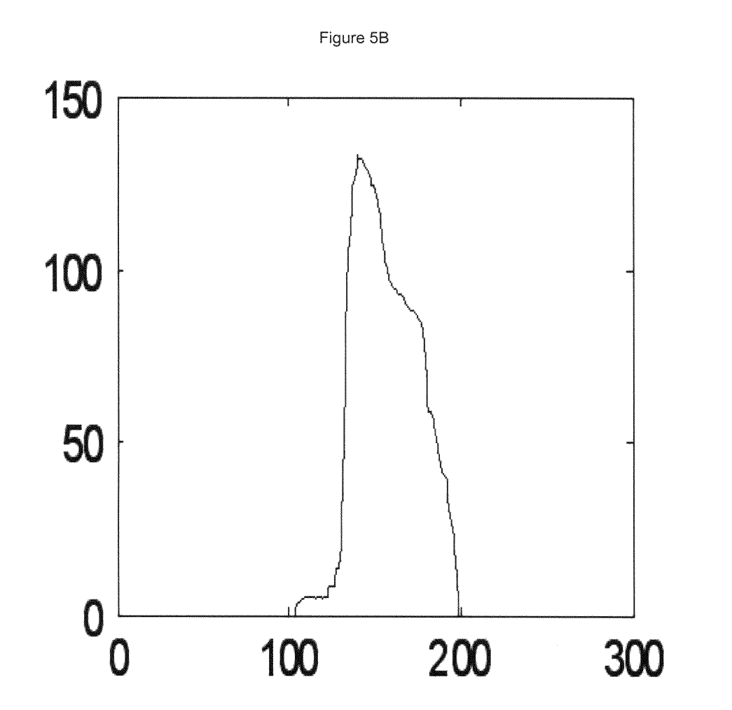

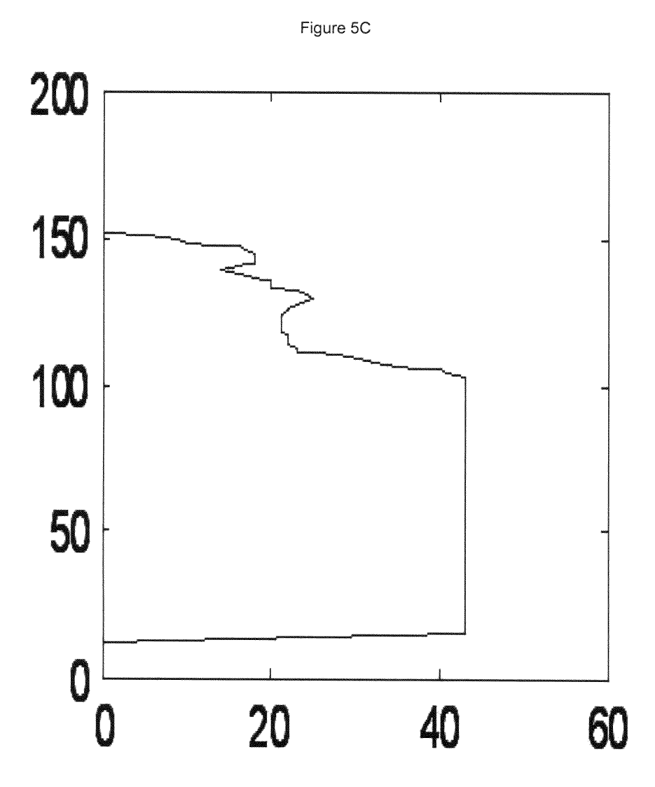

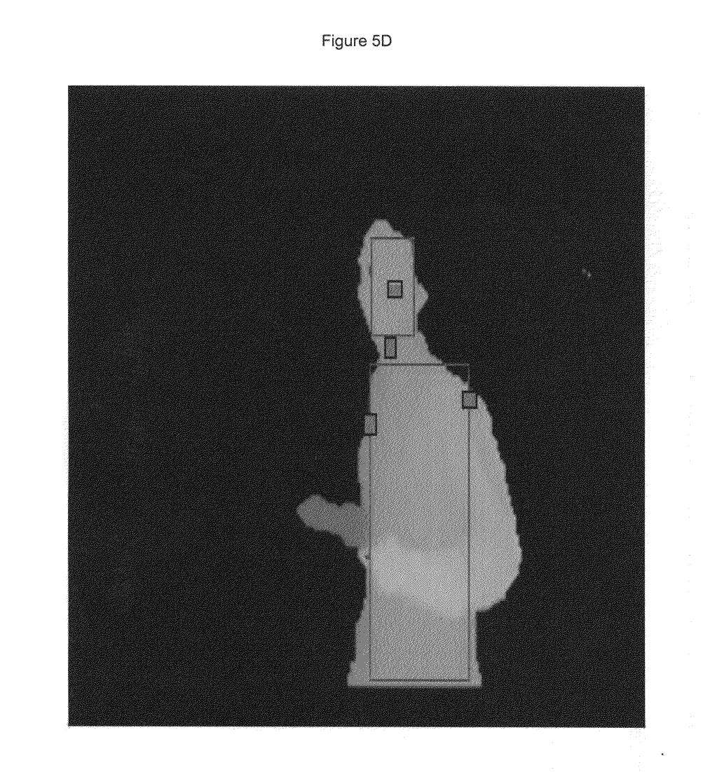

An image preprocessing procedure according to embodiments is described with reference to FIGS. 4 and 5A-5D. FIG. 4 illustrates an image processing procedure of the preprocessing module 102 according to an embodiment.

Referring to FIG. 4, the preprocessing module 102 divides a human body posture based on an intensity image to extract an outline. In this case, a threshold value division method may be used.

In operation 402, the preprocessing module 102 may use divided area obtained by dividing the human body posture as a mask of a color image to extract a head and a body. When the preprocessing module 102 extracts the head and the body, the preprocessing module 102 may use a partial feature scheme and a measuring instrument training provided by a conventional AdaBoost scheme. The preprocessing module 102 may use several reference points to unify an image.

In operation 403, the preprocessing module 102 may select a location of eyes and a location of shoulders as the reference points. The location of the eyes is a robust reference point of a head area, and the location of the shoulders is a robust reference point of a body area. The preprocessing module 102 may use a conventional trained eye area detector to robustly extract the location of the eyes, and the eye area detector may be trained based on the AdaBoost scheme and the partial feature scheme. The preprocessing module 102 may use a simple method to robustly measure the location of the shoulders including a left shoulder point P_{LS} and a right shoulder point P_{RS} and the method may have an advantage of the depth image of the mask as illustrated in FIG. 4. The preprocessing module 102 may measure a curve point, as the shoulders points, among a vertical projection and a horizontal projection of the body area.

After measuring the location of the eyes and the location of the shoulders, the preprocessing modules 102 may unify a shape in operation 404. The shape is unified to generate a sample having an independent shape. P₁ denotes a center of a left eye and a right eye, P₂ denotes a center of the left shoulder point P_{LS} and the right shoulder point P_{RS}, D₁ denotes a distance between P₁ and P₂, and D₂ denotes a distance between the left shoulder point P_{LS} and the right shoulder point P_{RS}. D₁ is used as a reference length of a height (h) of the sample, and D₂ is used as a reference length of a width (w) of the sample. A share unifying unit 1024 may edit a sample based on a following formula and unifies the sample to have a size of 80×48. Particularly, D₂/D₁=5:2 is a ratio used for unifying the shape, and w=4×D₂ and h=6×D₁ are used as a size of a sample section. A collected image does not include a complex boxing motion, the preprocessing module 102 may edit the sample to unify the sample to a size of 80×80 and may set w=h=6×D₁.

FIG. 5 illustrates an example of measuring a location of shoulders according to an embodiment.

FIG. 5A is an outline of a foreground area of a human body.

FIG. 5B is a vertical histogram of an image, namely, a vertical histogram of the outline. A horizontal coordinate denotes a horizontal location of the image, namely, a column coordinate of the image, and a numerical range is between zero and a width of the image. A vertical coordinate denotes a value of a sum of all pixels in one column corresponding to a column coordinate of the image, namely, a projective value of the column coordinate in a vertical direction

FIG. 5C is a horizontal histogram of the image. A horizontal coordinate denotes a vertical location of the image, namely, a row coordinate of the image, and a numerical range zero to a height of the image. A vertical coordinate denotes a value of a sum of all pixels in one row corresponding to a row coordinate of the image, namely, a projective value of the row coordinate in a horizontal direction.

FIG. 5D is a result of measuring a location or an area of shoulders.

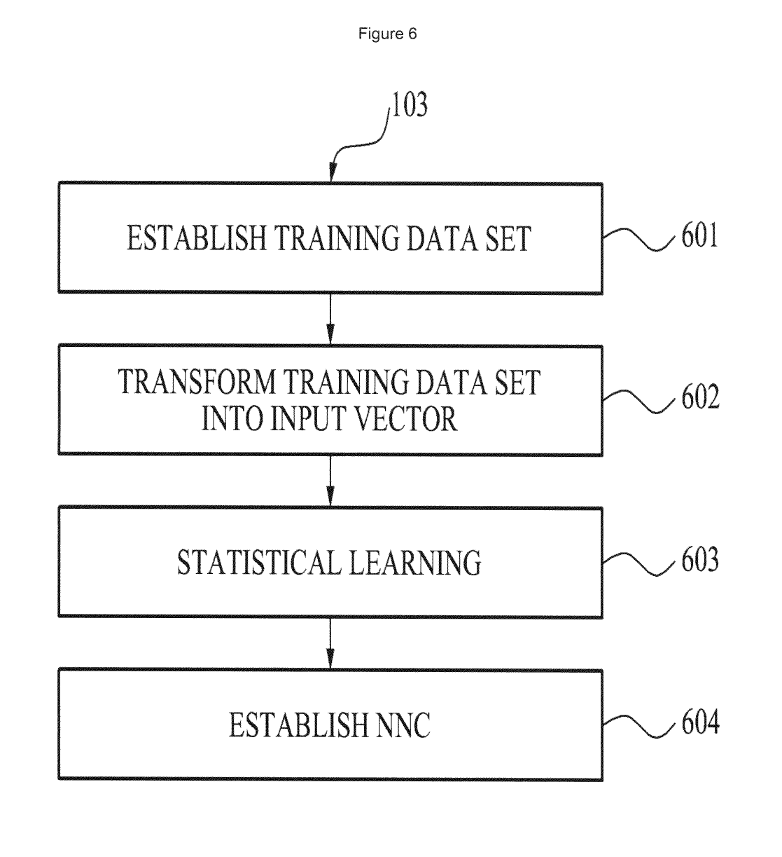

Subsequently, training of a classifier is described with reference to FIG. 6. FIG. 6 illustrates a training procedure of a classifier of the training module 103 of FIG. 1.

The training module 103 may calculate a projective transformation matrix from an original image space to a feature space based on a PCA method and an LLE learning method.

Referring to FIG. 6, the training module 103 establishes a training data set in operation 601. The standard of choosing the data of the training data set is to enable a training sample to be various and to be a representative, and is to enable the training data set to include various human postures, the training sample being a posture sample in a training operation. The training module 103 may select various training samples based on a different boxing posture, and uniformly distribute the various training samples in an image space.

Subsequently, the training module 103 may convert training sample data into an appropriate input vector to perform learning in operation 602. The training module 103 may directly convert 2D data into a 1D vector.

Subsequently, the training module 103 may decrease a dimension based on a statistical learning method, such as a PCA method, an LLE method, and the like, to calculate a projective transformation matrix in operation 603.

Subsequently, the training module 103 may establish an NNC having an L₁ distance denoting a measurement value of a degree of similarity, and L₁ is described below in operation 604.

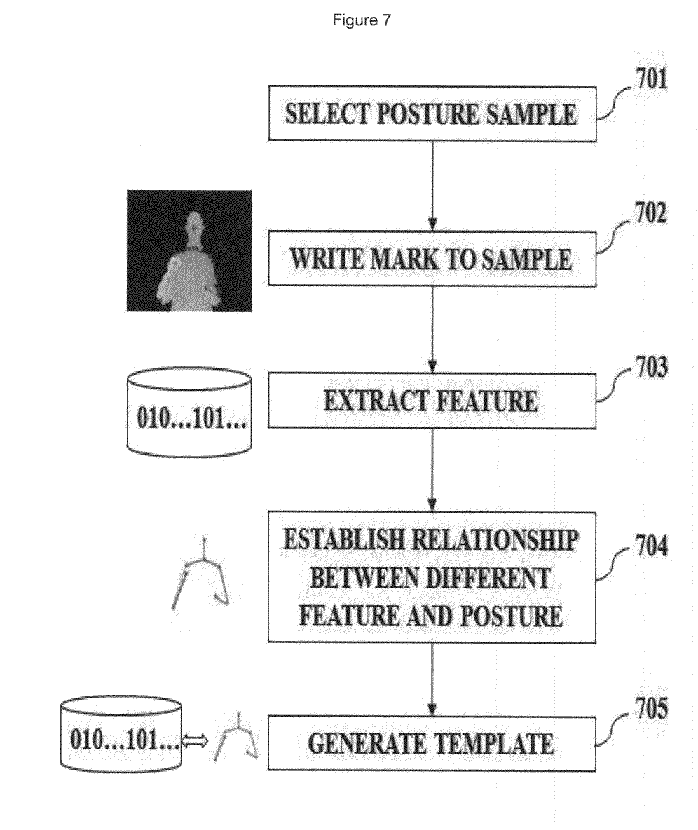

Subsequently, establishing of a template DB according to an embodiment is described with reference to FIG. 7. FIG. 7 illustrates a template database (DB) establishing procedure of the template database (DB) establishing module 104 of FIG. 1. The establishing of the template DB is an important part of a sample-based motion analysis.

Referring to FIG. 7, the template DB establishing module 104 may select a different posture sample in operation 701.

In operation 702, the template DB establishing module 104 may have a mark manually written for a posture sample image. The template DB establishing module 104 may generate a data set that is marked by a mark-based motion capture system or appropriate computer graphic software. The embodiment may collect eight boxing postures because of limitations of an apparatus and design, and a collecting procedure is omitted. The feature extracting module 105 may extract a different feature having a low dimension from the sample based on the projective transformation matrix calculated by the training module 103 in operation 703.

In operation 704, the template DB establishing module 104 establishes a relationship between the different feature and a posture or frame based on the extracted different feature. The present embodiment establishes relationships between the different feature and the eight boxing postures. Subsequently, the template DB establishing module 104 may generate a template including a feature vector and a related frame index or related motion index based on the established relationships in operation 705.

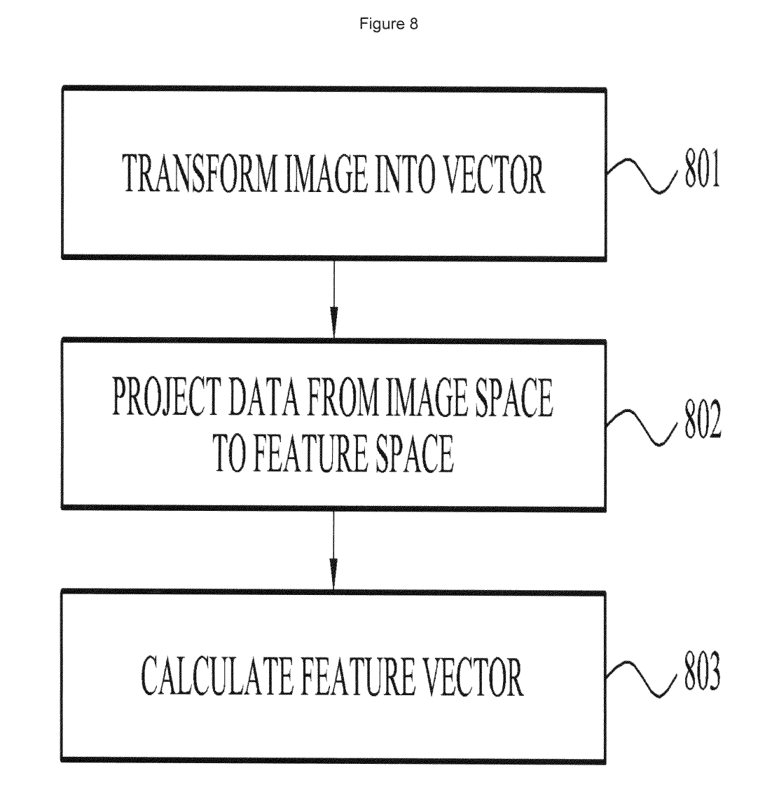

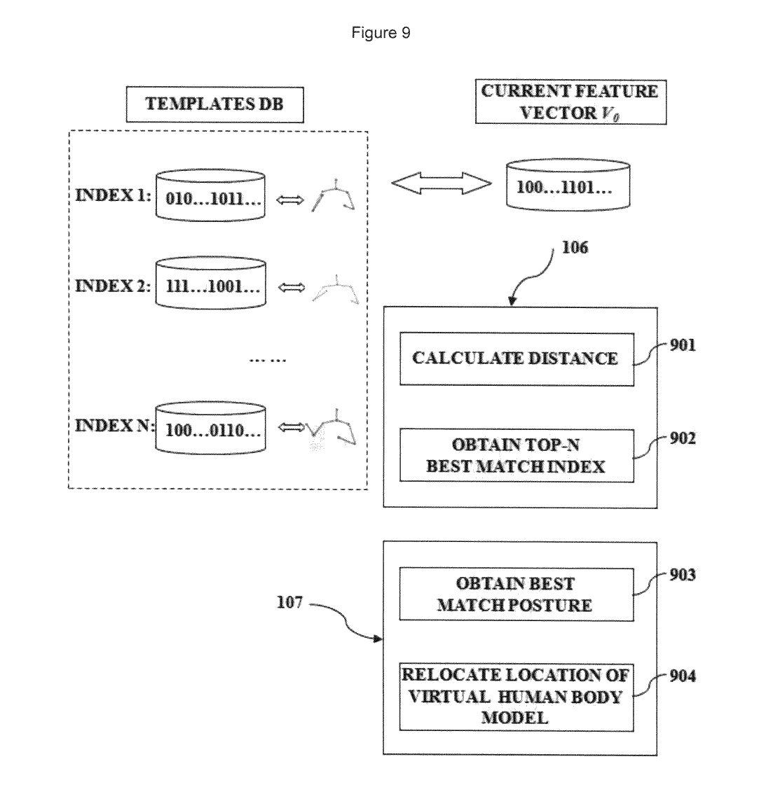

Referring to FIGS. 8 and 9, an on-line posture identification is described. The on-line posture identification may be performed after a classifier and the established appropriate template DB are trained. First, a preprocess with respect to an input image is performed in a similar manner as a training operation. Next operations may include extracting a feature, matching a feature, and outputting a human body posture.

FIG. 8 illustrates a feature extracting procedure of the feature extracting module 105, of FIG. 1, and FIG. 9 illustrates a feature matching procedure of the searching module 106 and a human body posture outputting procedure of the outputting module 107 of FIG. 1.

The feature extracting procedure is to extract a ‘distinguishing feature to match the distinguishing feature. Referring to FIG. 8, the feature extracting module 105 may transform depth information of an input image into an appropriate image vector, namely, may directly transform 2D data into 1D data in operation 801. Subsequently, the feature extracting module 105 may project data from an image space to a feature space based on a projective transformation matrix obtained calculated during the training operation in operation 802. A trained PCA and LLE projective transformation matrix may be used in the present embodiment.

X={x₁, x₂, . . . x_{N}} is assumed as input 1D image data and W is assumed as a trained PCA/LLE projective transformation matrix. In this case, N=w×h, w is a width of a sample, h is a height of the sample, W is of N×M dimensions, and M<<N. Accordingly, the feature extracting module 105 may calculate a feature vector V, namely, V=W_{T}X, and a dimension of the feature vector V is M in operation 803.

After extracting a feature, the feature extracting module 105 may extract top-n best match postures from a template database through an NNC. Specifically, the searching module 106 compares, through the NNC, a distinguishing posture feature extracted during a human identifying operation with a posture template stored in the template database, and may perform a human body posture matching.

Referring to FIG. 9, the searching module 106 calculates a distance between a current feature vector and a feature vector stored in the template database through the NNC in operation 901 in operation 901.

V₀ denotes the current feature vector, namely, an inputted feature vector, Vᵢ (i=1, . . . , N) denotes the feature vector stored in the template DB, Sᵢ (i=1, . . . , N) denotes a related frame index or a related posture index. Various measurement values of a degree of similarity may be calculated by matching the inputted feature vector V₀ with Vᵢ of the number N stored in the template DB based on L₁=|V₀−Vᵢ| (i=1, . . . , N).

In operation 902, the searching module 106 calculates top-n best match indexes from the template DB based on the L₁.

In operation 903, the outputting module 107 calculates a best match posture or a best match frame from the template DB based on the best match index. Subsequently, in operation 904, the outputting module 107 relocates a location of a virtual human body model based on the best match posture or the best match frame in operation 904.

For example, a posture template DB may be established during an off-line learning operation, and the posture template DB may include a single set of tai ji chuan (shadowboxing) motion set and may include 500 motion images. When the posture template DB is established, a feature vector is extracted for each human body motion and a joint is marked for each location. The outputting module 107 is easily operated for displaying of a virtual person. In the on-line motion identifying operation, when a user performs a motion, the preprocessing module 102 may capture an image of the motion to process a preprocessing, and the feature extracting module 105 may extract a different posture feature to calculate a feature vector of the motion. The searching module 106 may compare, through an NNC, the feature vector with 500 sets of feature vectors stored in the posture template DB to calculate a degree of similarity, and may determine n motions having a greatest similarity. The operation is a process of classifying top-n NN and when n is 1, a single motion that is a most similar motion is determined.

The outputting module 107 may output information associated with a human body joint point corresponding to the motion to operate or to display a virtual person.

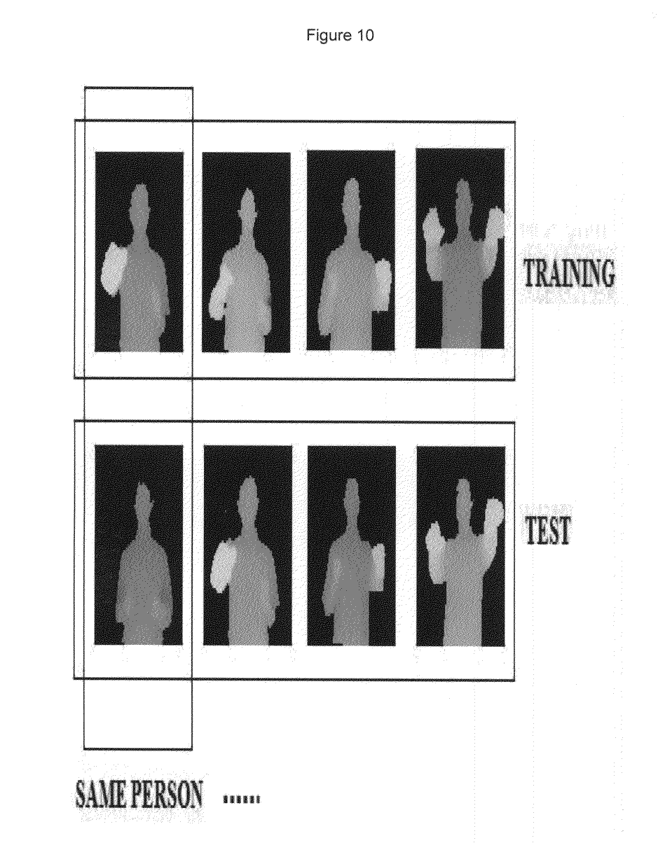

Subsequently, experiment 1 and experiment 2 are described with reference to FIGS. 10 through 13.

Referring to FIG. 10, experiment 1 is performed with respect to a predetermined person. Training data may include posture data about persons to be tested. A training operation is associated with four persons, includes eight boxing motions, and includes 1079 samples. A size of each sample is 80×80. A location of a human body model is measured based on a 100-dimension.

A test operation is associated with four persons which is same as the training operation, includes eight boxing motions, and performs a test with respect to 1079 samples.

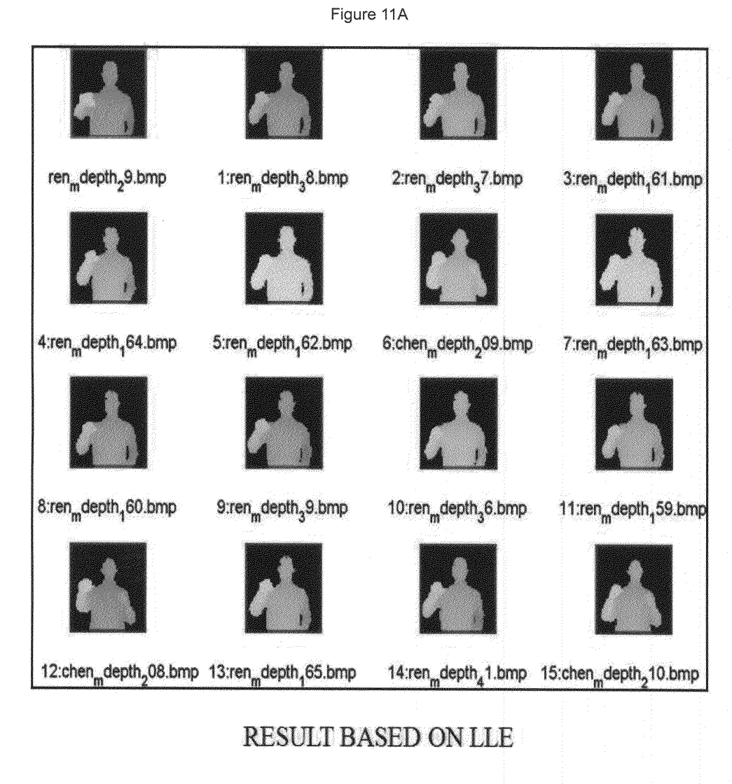

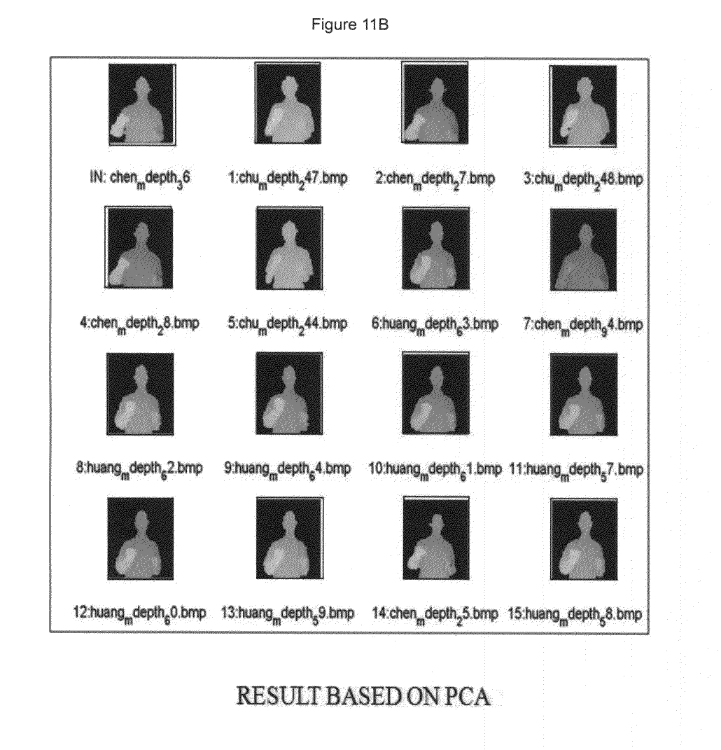

FIGS. 11A and 11B illustrates a result of experiment 1. An output of FIG. 11A is a result of searching based on an LLE method. Another output of FIG. 11B is a result of searching based on a PCA method. An image on a top of a left side of the output FIG. 11A and the other output of FIG. 11B is inputted as a target of the searching, and remaining images are outputted as return values.

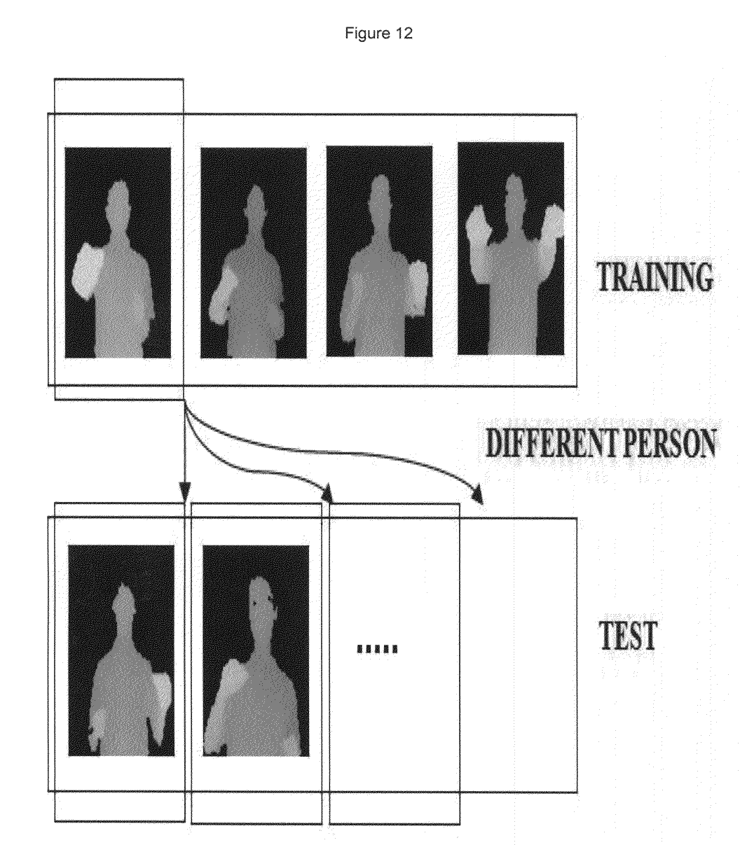

Referring to FIG. 12, experiment 2 is performed with respect to any person. Training data may not include posture data of a tested person. A training operation is associated with four persons, includes eight boxing motions, and includes 1079 samples. A location of a human body model is relocated based on a 100-dimension. A test operation is associated with two persons who are different from the training operation, includes eight boxing motions, and performs a test with respect to 494 samples.

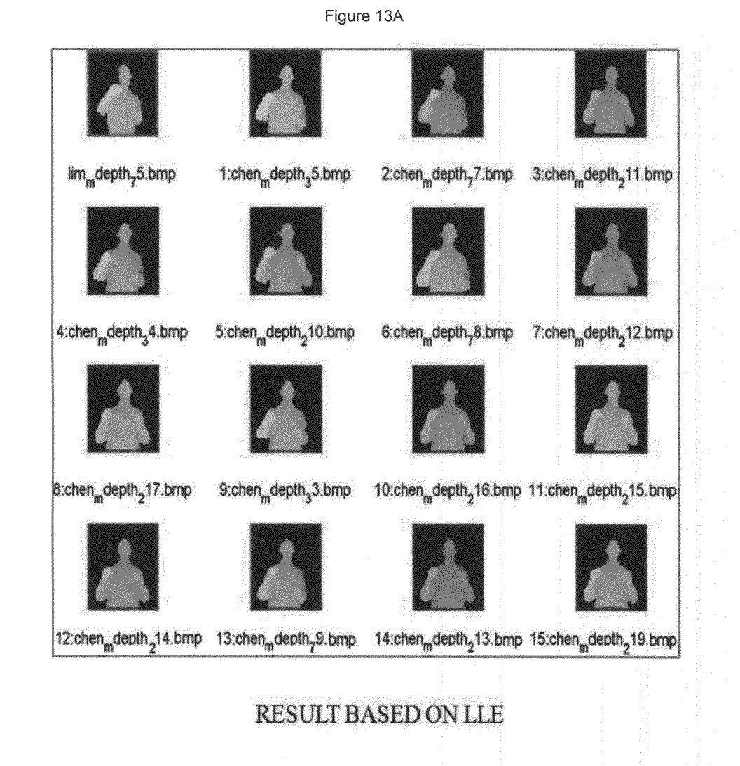

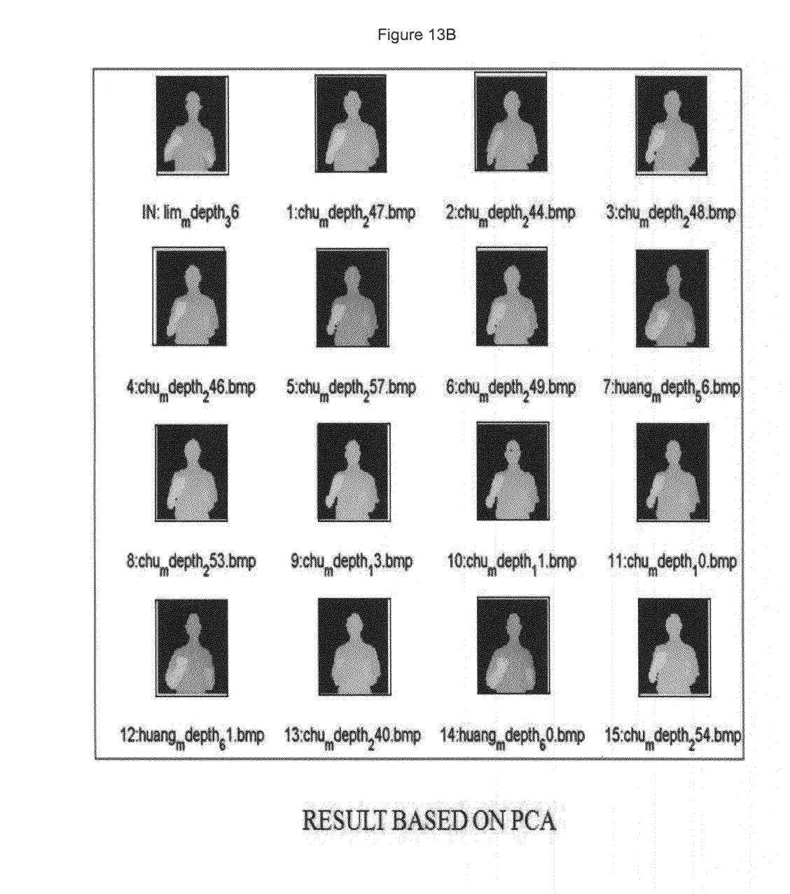

FIGS. 13A and 13B are a result of experiment 2. An output of FIG. 13A is a result of searching based on an LLE method. Another output of FIG. 13B is a result of searching based on a PCA method. An image on a top of a left side of the output FIG. 13A and the other output of FIG. 13B is inputted as a target of the searching, and remaining images are outputted as return values.

Accordingly, compared with a traditional color image based method, embodiments may overcome an ambiguity of an outline based on depth data. Embodiments may provide a method of unifying a shape based on depth information and color information and the method may identify a posture having a distinguishing posture. In addition, embodiments may use a statistical learning method and a quick searching method, and thus, a structure of a human posture identifying apparatus is simple and is effectively operated.

The human body posture identifying method for depth adjusting according to the above-described example embodiments may also be implemented through computer readable code/instructions in/on a non-transitory medium, e.g., a non-transitory computer readable medium, to control at least one processing element to implement any above described embodiment. The non-transitory medium can correspond to medium/media permitting the storing or transmission of the computer readable code.

The computer readable code can be recorded or transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media. The media may also be a distributed network, so that the computer readable code is stored or transferred and executed in a distributed fashion. Still further, as only an example, the processing element could include a processor or a computer processor, and processing elements may be distributed or included in a single device.

In addition to the above described embodiments, example embodiments can also be implemented as hardware, e.g., at least one hardware based processing unit including at least one processor capable of implementing any above described embodiment.

Although a few embodiments have been shown and described, it would be appreciated by those skilled in the art that changes may be made in these embodiments without departing from the principles and spirit of the disclosure, the scope of which is defined by the claims and their equivalents.

What is claimed is:

1. An apparatus identifying a human body posture, the apparatus comprising:
an input module including a depth camera and a color camera to simultaneously capture the human body posture to generate an input image;
a preprocessing module to perform a preprocess to convert the input image into an appropriate format, to unify a size of the input image based on a predetermined size, and to generate a posture sample having an independent shape to generate sample data;
a training module to calculate a projective transformation matrix from an original image space to a feature space by decreasing a dimension of the sample data based on a statistical learning method during a training operation, and to establish a nearest neighbor classifier (NNC);
a feature extracting module to extract a distinguishing posture feature from the sample data based on the projective transformation matrix during each of the training operation and a human body posture identifying operation;
a template database establishing module to establish a posture template database based on the distinguishing posture feature extracted by the feature extracting module during the training operation;
a searching module to perform a human body posture matching by comparing, through the NNC, the distinguishing posture feature extracted by the feature extracting module during the human body posture identifying operation with a posture template stored in the posture template database; and
an output module to output a match posture, and to relocate a location of a virtual human body model based on the match posture.

2. The apparatus of claim 1, wherein:
the depth camera generates an depth image and an intensity image of the human body posture; and
the color camera generates an color image of the human body posture.

3. The apparatus of claim 2, wherein the preprocessing module divides the human body posture based on the intensity image to extract an outline, detects a head and a body based on divided areas obtained by dividing the human body posture, unifies a shape using a location of eyes and a location of shoulders as reference points, and generates the posture sample having the independent shape.

4. The apparatus of claim 3, wherein the training module generates a training data set for a uniform distribution in an image space of the posture sample, transforms the sample data to an input vector, and calculates the projective transformation matrix by decreasing the dimension of the sample data based on the statistical learning method.

5. The apparatus of claim 4, wherein the statistical learning method includes a principle component analysis (PCA) method and a local linear embedding (LLE) method.

6. The apparatus of claim 5, wherein:
the template database establishing module selects a different posture sample and have a mark manually written for a posture sample image;
the feature extracting module to extract, from a posture sample, a distinguishing feature having a low dimension based on the projective transformation matrix; and
the template database establishing module establishes a relationship between the distinguishing feature and a posture based on the extracted distinguishing feature, and generates a template including a feature vector and a related posture index based on the established relationship to establish a template database.

7. The apparatus of claim 6, wherein the feature extracting module transforms depth data of the input image into a one-dimension data vector, and projects data from the image space to the feature space using the projective transformation matrix calculated during the training operation to calculate a feature vector.

8. The apparatus of claim 7, wherein the searching module calculates a distance between a current feature vector and a feature vector in the template database using the NNC to calculate a best match index from the template database based on the calculated distance.

9. The apparatus of claim 8, wherein the output module obtains the best match posture from the template database based on the best match index, and relocates the location of the virtual human body model based on the best match posture.

10. A method of identifying a human body posture, the method comprising:
simultaneously capturing a human body posture using both a depth camera and a color camera to generate an input image;
performing a preprocess to transform the input image into an appropriate format, unifying a size of the input image based on a predetermined size, generating a posture sample having an independent shape to generate sample data;
calculating a projective transformation matrix from an original image space to a feature space by decreasing a dimension of the sample data based on a statistical learning method during a training operation, and establishing nearest neighbor classifier (NNC);
extracting a distinguishing posture feature from the sample data based on the projective transformation matrix during each of the training operation and a human body posture identifying operation;
establishing a posture template database based on the distinguishing posture feature extracted during the training operation;
performing a human body posture matching by comparing, through the NNC, the distinguishing posture feature extracted during the human body posture identifying operation with a posture template stored in the posture template database; and
outputting a match posture, and to relocate a location of a virtual human body model based on the match posture.

11. The method of claim 10, wherein:
the depth camera generates an depth image and an intensity image of the human body posture; and
the color camera generates an color image of the human body posture.

12. The method of claim 11, wherein operation performing the process comprises:
dividing the human body posture based on the intensity image to extract an outline;
detecting a head and a body based on divided areas obtained by dividing the human body posture; and
unifying a shape using a location of eyes and a location of shoulders as reference points, and generating the posture sample having the independent shape.

13. The method of claim 12, wherein operation the calculating comprises:
generating a training data set for a uniform distribution in an image space of the posture sample;
transforming the sample data to an input vector; and
calculating the projective transformation matrix by decreasing the dimension of the sample data based on the statistical learning method.

14. The method of claim 13, wherein the statistical learning method includes a principle component analysis (PCA) method and a local linear embedding (LLE) method.

15. The method of claim 14, wherein operation the establishing comprises:
selecting a different posture sample and manually writing a mark for a posture sample image;
establishing a relationship between a distinguishing feature extracted during the training operation and a posture based on the extracted distinguishing feature, and
generating a template including a feature vector and a related posture index based on the established relationship to establish a template database.

16. The method of claim 15, wherein operation the extracting comprises:
transforming depth data of the input image into a one-dimension data vector; and
projecting data from the image space to the feature space using the projective transformation matrix calculated during the training operation to calculate a feature vector.

17. The method of claim 16, wherein operation the performing the human body posture matching comprises:
calculating a distance between a current feature vector and a feature vector in the template database using the NNC; and
obtaining a best match index from the template database based on the calculated distance.

18. The method of claim 17, wherein operation the outputting comprises:
obtaining the best match posture from the template database based on the best match index; and
relocating the location of the virtual human body model based on the best match posture.

19. A non-transitory computer readable recording medium storing a program implementing the method of 10.

20. The apparatus of claim 1, wherein the match posture is a best match posture.
